(19) United States
(12) Patent Application Publication
(10) Pub. No.: US 2012/0038170 A1
(43) Pub. Date: Feb. 16, 2012

(54) Wind Energy Generating and Storing System

(76) Inventors: Alex J. Stuart, Winnipeg (CA); Justin David Phillips, Winnipeg (CA)

(21) Appl. No.: 13/266,596

(22) PCT Filed: Apr. 28, 2010
(86) PCT No.: PCT/CA2010/000614

§ 371 Date: Oct. 27, 2011

Related U.S. Application Data
(60) Provisional application No. 61/173,236, filed on Apr. 28, 2009.

(51) Int. Cl. F03D 9/02

(52) U.S. Cl. 290/55

(57) ABSTRACT

A wind energy system includes a vertical-axis turbine and a compressor driven by the turbine. The turbine includes blades supported on a central rotor by respective support arms having an airfoil shape so as to generate a load on the rotor in an axial direction so as to affect the performance of the compressor. The compressor rotor and the turbine rotor can be integrally coupled with one another for rotation together about a common vertical axis to minimize drive transmission losses. A primary and a secondary compressed air driven generators generate respective primary and secondary electricity from a common source of compressed air. The primary generator is controlled by an electrical controller which is powered by the secondary electricity.

This application claims priority benefits from U.S. provisional application Ser. No. 61/173,236, filed Apr. 28, 2009.

### FIELD OF THE INVENTION

The present invention relates to a wind energy system comprising a vertical-axis turbine which drives a compressor to compress and store air for subsequent use, for example for generating electricity.

### BACKGROUND

The desire to make use of renewable energy is well-known and many attempts have been made to provide more efficient use of renewable energy sources so that renewable energy sources are more economical for users. Examples of prior art wind turbine systems can be found in the following patent documents: US patent publication 2006/0266036 by Ingersoll; US patent publication 2005/0016165 by Enis et al; U.S. Pat. No. 7,067,937 by Enish et al.; WO patent application 2008/023901 by Korea Institute of Machinery & Materials and WO patent application 2007/136731 by General Compression, Inc.

US publication 2006/0266036 by Ingersoll in particular discloses a wind generating system with an off-shore direct compression wind station. As described, in the preferred embodiment the turbine is coupled to drive a compressor by a friction wheel drive connected by a belt, a chain or gear of the compressor. The extra mechanical transmission of rotary force of the turbine to the compressor generally results in a loss of efficiency; however the mechanical drive transfer is typically required for accommodating a different turning ratio of the compressor and the turbine components in the horizontal turbine disclosed.

Some of the prior art examples rely on storage of compressed air for later use in generating electricity or other applications and the like. In each instance however some electrical energy must be stored in batteries for operating the control systems which control operation of the turbine and other electrical components of the system. Use of batteries is generally understood to be undesirable due to the negative effects thereof on the environment.

### SUMMARY OF THE INVENTION

According to one aspect of the present invention there is provided a A wind energy system comprising:

a vertical-axis turbine comprising:

a supporting structure;

a turbine rotor supported on the supporting structure for rotation about a vertical axis relative to the supporting structure;

a plurality of turbine blades supported on the turbine rotor at circumferentially spaced locations about the vertical axis so as to be rotatable with the rotor about the vertical axis; and

a plurality of support arms spanning radially outward from the turbine rotor to support the turbine blades thereon spaced outwardly from the rotor;

the turbine blades of the vertical-axis turbine having an airfoil shape in cross section and being oriented such that the blades generate a torque in an operating direction of rotation of the turbine about the vertical axis responsive to a generally horizontal wind across the blades as the blades are rotated in the operating direction of rotation;

the support arms of the vertical-axis turbine having an airfoil shape in cross section and being oriented such that the support arms generate a load on the turbine rotor in an axial direction of the vertical axis responsive to rotation of the rotor in the operating direction of rotation;

a turbomachine comprising a casing and a turbomachine rotor which are rotatable relative to one another, one of the casing and the turbomachine rotor being coupled to the turbine rotor so as to rotate responsive to rotation of the turbine rotor.

The turbomachine may comprise any type of pump, compressor, auger or other turbomachinery capable of converting a rotating mechanical input into a movement of a fluid including incompressible fluids such as water or compressible fluids such as a gas which is compressed by the turbomachine.

In the illustrated embodiment, the turbomachine comprises an air compressor comprising:

a stator including an inlet end and an outlet end; and

a compressor rotor supported for rotation relative to the stator about the vertical axis of the vertical-axis turbine;

the compressor rotor being arranged to compress air from the inlet end to the outlet end of the stator responsive to rotation of the compressor rotor relative to the stator; and

the compressor rotor being coupled to the turbine rotor so as to rotate responsive to rotation of the turbine rotor.

By further providing support arms for the turbine blades which are shaped to provide an axial thrust, the performance of the compressor can be improved either by reducing friction by carrying some of the weight of the compressor and turbine or by providing a more positive engagement of sealing members within the compressor.

The support arms may be oriented such that the support arms are arranged to provide an upward lifting force to the turbine rotor responsive to rotation of the turbine rotor in the operating direction of rotation.

When there is provided at least one sealing member in sealing engagement between the stator and the compressor rotor, preferably the support arms are oriented such that the support arms are arranged to provide a compressive force in an axial direction of the vertical axis on said at least one sealing member in sealing engagement between the stator and the compressor rotor.

According to a second aspect of the present invention there is provided a wind energy system comprising:

a vertical-axis turbine comprising:
a supporting structure;
a turbine rotor supported on the supporting structure for rotation about a vertical axis relative to the supporting structure; and
a plurality of turbine blades supported on the rotor at circumferentially spaced locations about the vertical axis so as to be rotatable with the rotor about the vertical axis;

the blades of the vertical-axis turbine having an airfoil shape in cross section and being oriented such that the blades generate a torque in an operating direction of rotation of the turbine about the vertical axis responsive to a generally horizontal wind across the blades as the blades are rotated in the operating direction of rotation;

an air compressor comprising:
a stator including an inlet end and an outlet end;
a compressor rotor supported for rotation relative to the stator about a respective compressor axis;
the compressor rotor being arranged to compress air from the inlet end to the outlet end of the stator responsive to rotation of the compressor rotor relative to the stator;
the compressor rotor being coupled to the turbine rotor so as to rotate responsive to rotation of the turbine rotor;

at least one compressed air storage container in communication with the outlet end of the stator of the air compressor so as to be arranged to receive and store compressed air therein;

a primary compressed air driven generator arranged to generate primary electricity responsive to a flow of compressed air;

a secondary compressed air driven generator arranged to generate secondary electricity responsive to a flow of compressed air; and

a controller arranged to operate electric components of the wind energy generating and storing system using the secondary electricity generated by the secondary compressed air driven generator.

In some embodiments use of a secondary generator in addition to a primary generator driven by compressed air permits a continuous supply of electricity sufficient for powering the control systems of the wind energy system without any additional batteries being required so as to be more environmentally friendly than known prior art configurations of wind energy storage using compressed air that require batteries for operating the electrical components in remote locations.

The primary and secondary compressed air driven generators may be coupled to said at least one compressed air storage container such that the secondary compressed air driven generator receives a smaller flow of compressed air than the primary compressed air driven generator.

The secondary compressed air driven generator may be coupled to said at least one compressed air storage container such that the secondary compressed air driven generator receives a continuous flow of compressed air.

When there is provided an electrical power regulator arranged to regulate the primary electricity generated by the primary compressed air driven generator, the electrical power regulator is preferably operable using secondary electricity generated by the secondary compressed air driven generator.

When there is provided a plurality of primary compressed air driven generators arranged to generate electricity responsive to a flow of compressed air, the plurality of primary compressed air driven generators are preferably selectively operable in stages by the controller which uses the secondary electricity generated by the secondary compressed air driven generator.

There may be provided a valve mechanism arranged to controllably communicate compressed air from said at least one compressed air storage container to the primary compressed air generator and the controller is arranged to control the valve mechanism using the secondary electricity generated by the secondary compressed air driven generator.

According to a further aspect of the invention there is provided wind energy system comprising:

a vertical-axis turbine comprising:
a supporting structure;
a turbine rotor supported on the supporting structure for rotation about a vertical axis relative to the supporting structure; and
a plurality of turbine blades supported on the rotor at circumferentially spaced locations about the vertical axis so as to be rotatable with the rotor about the vertical axis;
the blades of the vertical-axis turbine having an airfoil shape in cross section and being oriented such that the blades generate a torque in an operating direction of rotation of the turbine about the vertical axis responsive to a generally horizontal wind across the blades as the blades are rotated in the operating direction of rotation;

a turbomachine comprising a casing and a turbomachine rotor which are rotatable relative to one another;

wherein one of the casing and the turbomachine rotor are integrally coupled with the turbine rotor so as to be rotatable together about the vertical axis.

As noted above, the turbomachine may comprise any type of pump, compressor, auger or other turbomachinery capable of converting a rotating mechanical input into a movement of a fluid including incompressible fluids such as water or compressible fluids such as a gas which is compressed by the turbomachine.

In the illustrated embodiment, the turbomachine comprises an air compressor comprising:

a stator including an inlet end and an outlet end; and

a compressor rotor supported for rotation relative to the stator about the vertical axis of the vertical-axis turbine;

the compressor rotor being arranged to compress air from the inlet end to the outlet end of the stator responsive to rotation of the compressor rotor relative to the stator; and

the compressor rotor being coupled to the turbine rotor so as to rotate responsive to rotation of the turbine rotor.

By providing turbine blades on a rotor which is integrally connected with the rotor of the compressor for rotation together about a common vertical axis in a vertical axis turbine as in the present invention, the efficiency losses of a drive transmission between a turbine and a compressor can be eliminated while the compressor is maintained within an optimal operating speed by the configuration of the vertical-axis turbine which is connected thereto.

The compressor may comprise any rotary type compressor including axial, scroll, or spiral type compressors. In the illustrated embodiment, the compressor comprises a spiral compressor.

When the air compressor comprises a spiral compressor in which one of the compressor rotor and the stator comprises a housing and the other one of the compressor rotor and the stator comprises a spiral member supported within the housing for rotation relative to the housing about the vertical axis, the housing and the spiral member preferably comprise cooperating surfaces arranged to compress air therebetween from the inlet end to the outlet end responsive to relative rotation between the housing and the spiral member.

When the stator comprises the spiral member and the compressor rotor comprises the housing, the turbine rotor may be formed integrally with the compressor rotor such that the turbine blades are supported directly on the housing of the air compressor for rotation together therewith about the spiral member.

When the stator of the air compressor comprises the housing and the compressor rotor comprises the spiral member rotatable within the housing, the turbine rotor may comprise a casing supported rotatably about the housing of the air compressor and joined integrally with the spiral member of the compressor adjacent the inlet end of the air compressor such that the turbine blades are rotatable together with the spiral member about the vertical axis.

When the stator of the air compressor comprises the housing and the compressor rotor comprises the spiral member rotatable within the housing, the turbine rotor may comprise a casing supported rotatably above the housing of the air compressor and joined integrally with the spiral member of the compressor adjacent the inlet end of the air compressor such that the turbine blades are rotatable together with the spiral member about the vertical axis.

There may be provided a permanent magnet electric generator comprising an electromagnetic coil and a permanent magnet supported for rotation relative to the electromagnetic coil in which one of the permanent magnet and the electromagnetic coil are coupled to the turbine rotor for rotation therewith about the vertical axis of the turbine such that the electromagnetic coil is arranged to generate an electrical current responsive to rotation of the turbine rotor.

The electromagnetic coil may be supported on the supporting structure and the permanent magnet may be supported on the turbine rotor for rotation about the electromagnetic coil.

There may be provided an electrical controller arranged to supply electrical current to the electromagnetic coil such that the electromagnetic coil resists movement relative to the permanent magnet in the operating direction of rotation.

The system may further comprise: at least one compressed air storage container in communication with the outlet end of the stator of the air compressor so as to be arranged to receive and store compressed air therein; and an auxiliary compressor including a stator and compressor rotor driven by an electric motor and arranged to compressed air and communicate the compressed air to said at least one compressed air storage container; wherein the electric motor is coupled to the permanent magnet electric generator such that the permanent magnet electric generator is arranged to drive the auxiliary compressor.

The system may yet further comprise:

at least one compressed air storage container in communication with the outlet end of the stator of the air compressor so as to be arranged to receive and store compressed air therein;

an auxiliary compressor including a stator and compressor rotor driven by an electric motor and arranged to compressed air and communicate the compressed air to said at least one compressed air storage container; and

a solar panel arranged to supply solar generated electricity to drive the electric motor of the auxiliary compressor.

The system may also further comprise:

at least one compressed air storage container in communication with the outlet end of the stator of the air compressor so as to be arranged to receive and store compressed air therein;

a controller arranged to control operation of the turbine in which the controller and said at least one compressed air storage container are located at a remote location separate from the vertical-axis turbine;

a plurality of modular communicating members connected in series between the turbine and the remote location of the controller and said at least one compressed air storage container;

each communicating member comprising a compressed air passage in communication between opposed tubing connectors and an electrical communicating member integrally attached alongside the compressed air passage in communication between opposed electrical connectors;

the opposed electrical connectors being arranged for mating connection with the electrical connectors of adjacent ones of the communicating members together with mating connection of the tubing connectors with the tubing connectors of the adjacent ones of the communicating members.

Some embodiments of the invention will now be described in conjunction with the accompanying drawings in which:

### BRIEF DESCRIPTION OF THE DRAWINGS

FIG. 1 is a schematic overview of the wind energy system.

FIG. 2 is a top plan view of the vertical-axis turbine.

FIG. 3 is a sectional view along the line A-A of FIG. 2 according to a first embodiment of the turbine.

FIG. 4 is a partly sectional perspective view of the turbine according to

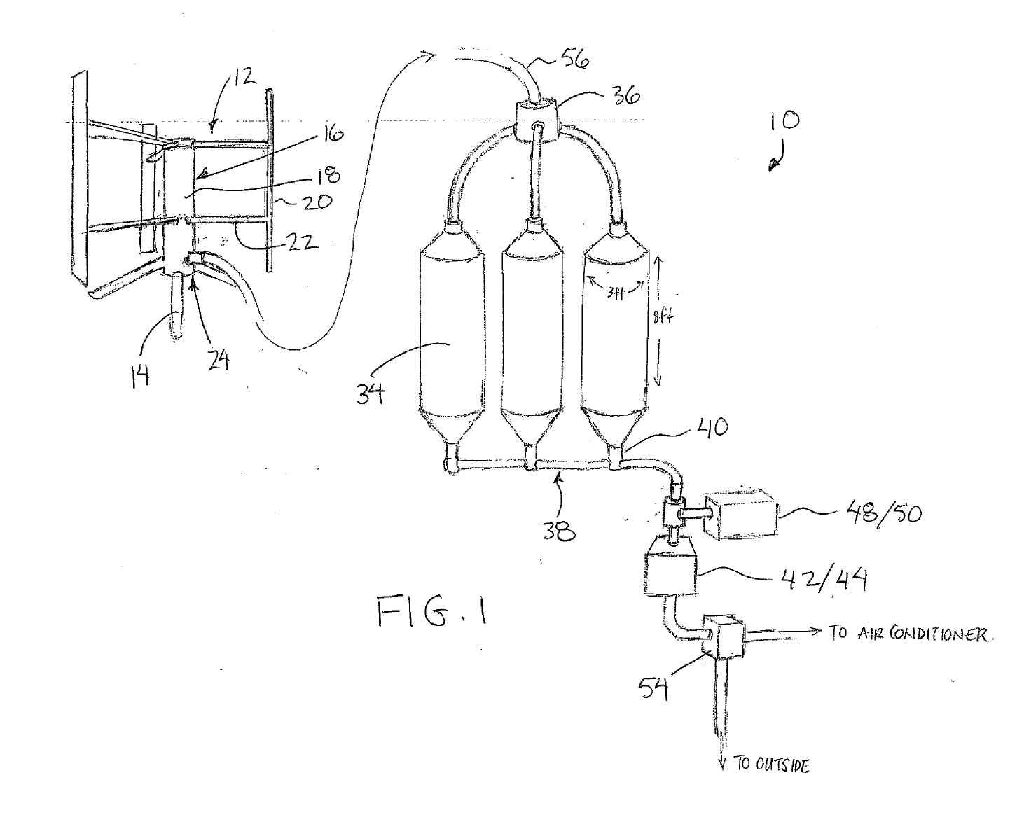

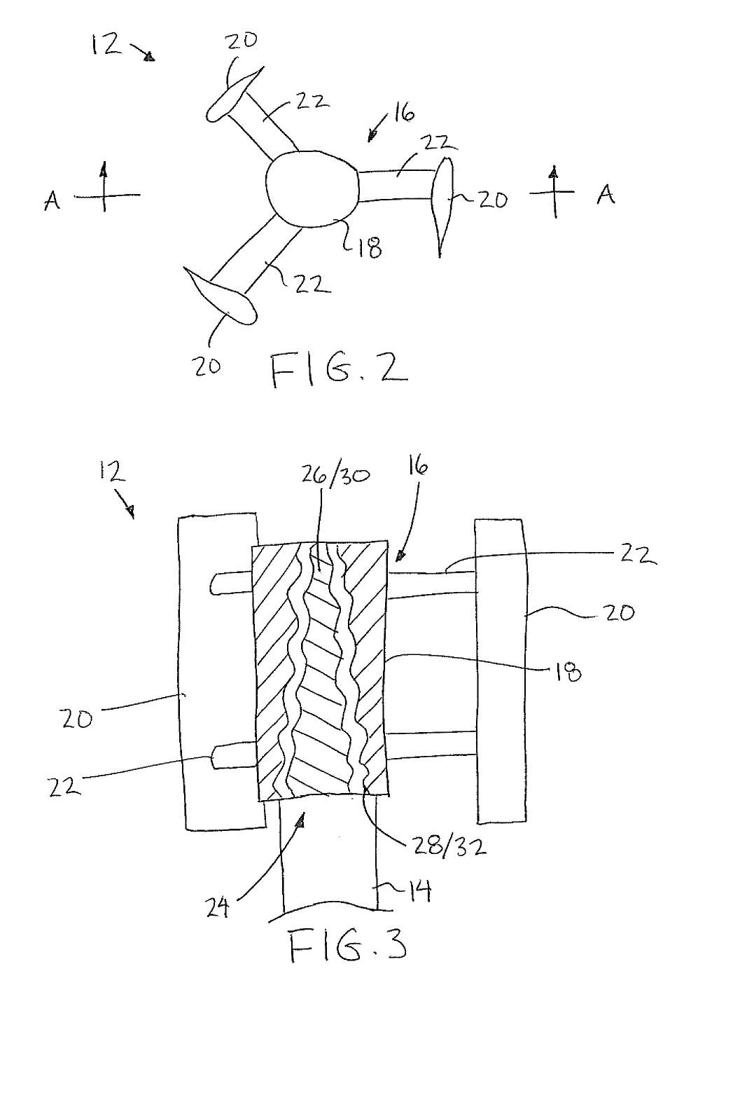

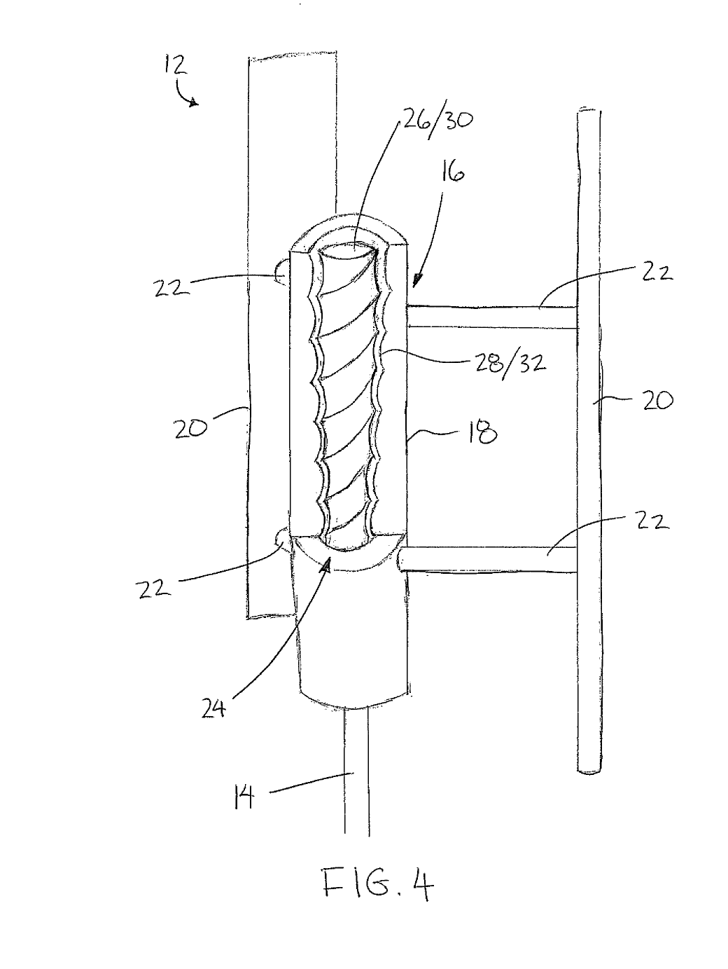

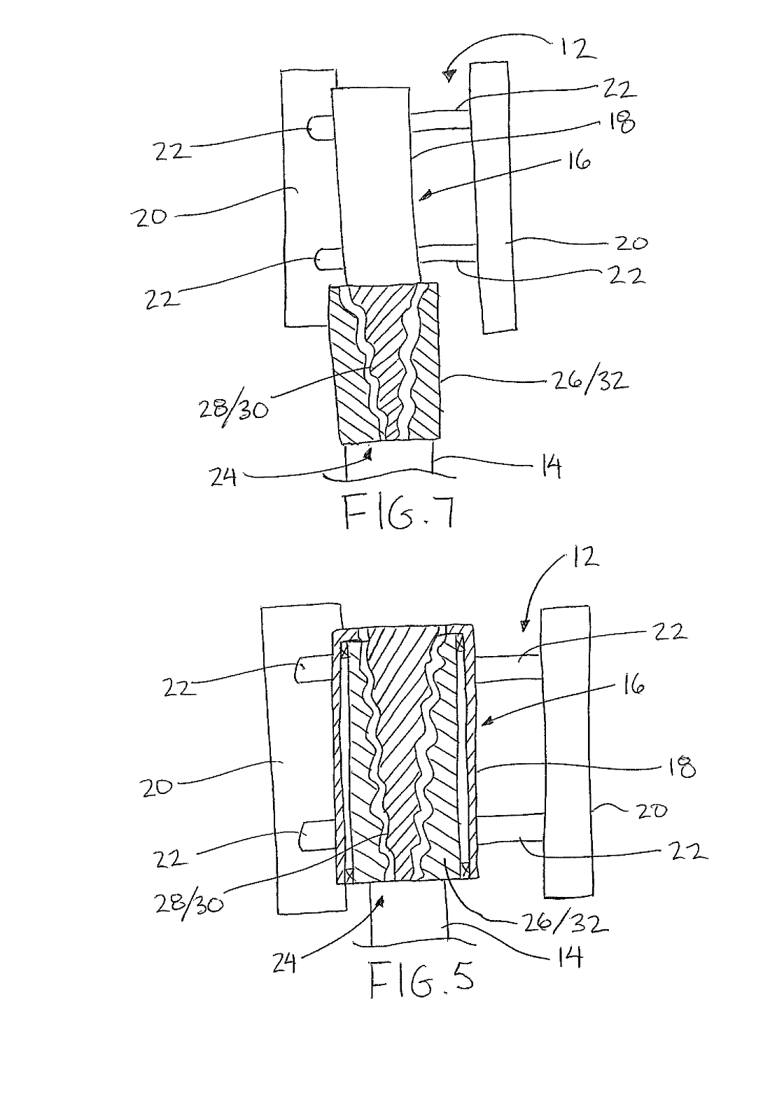

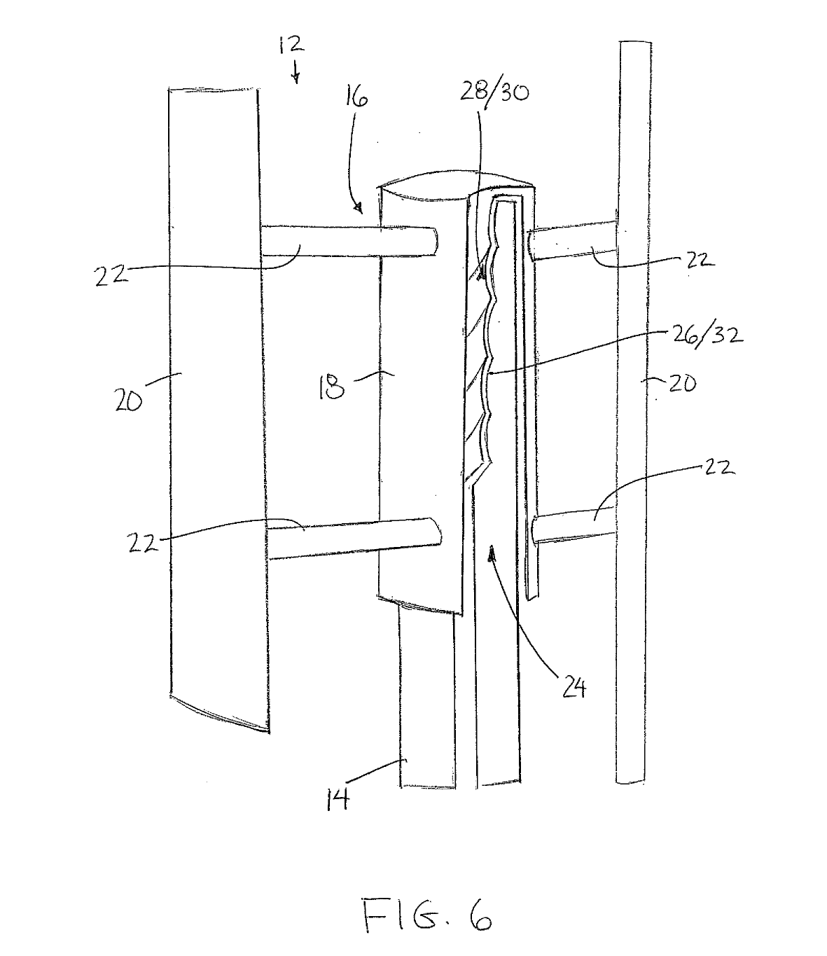

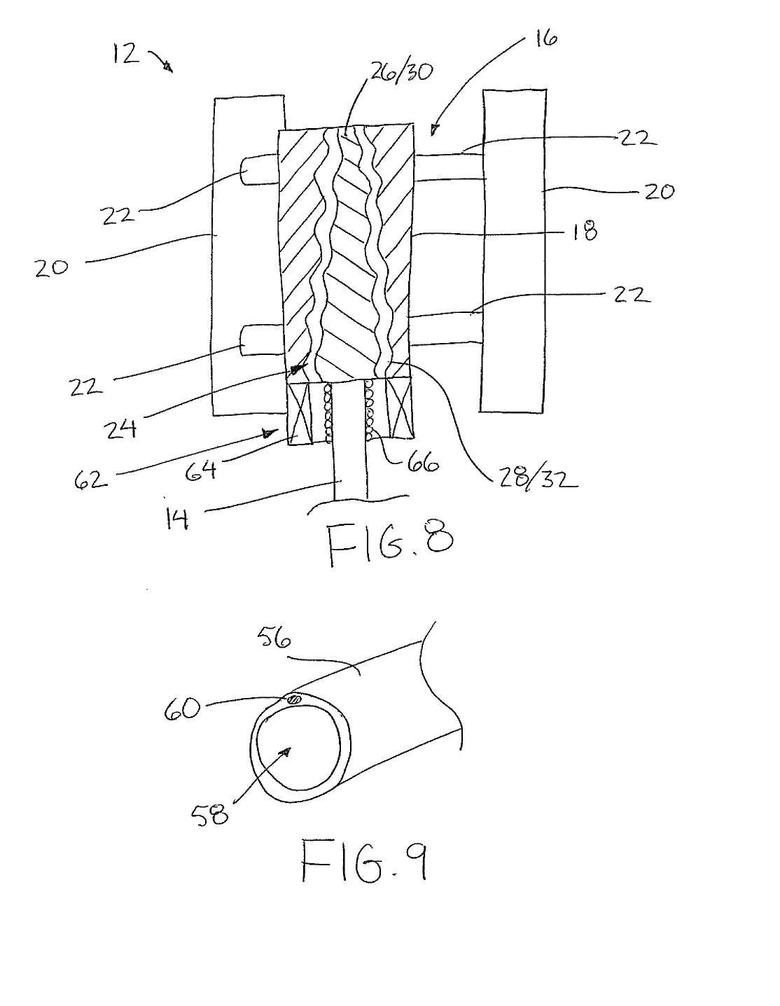

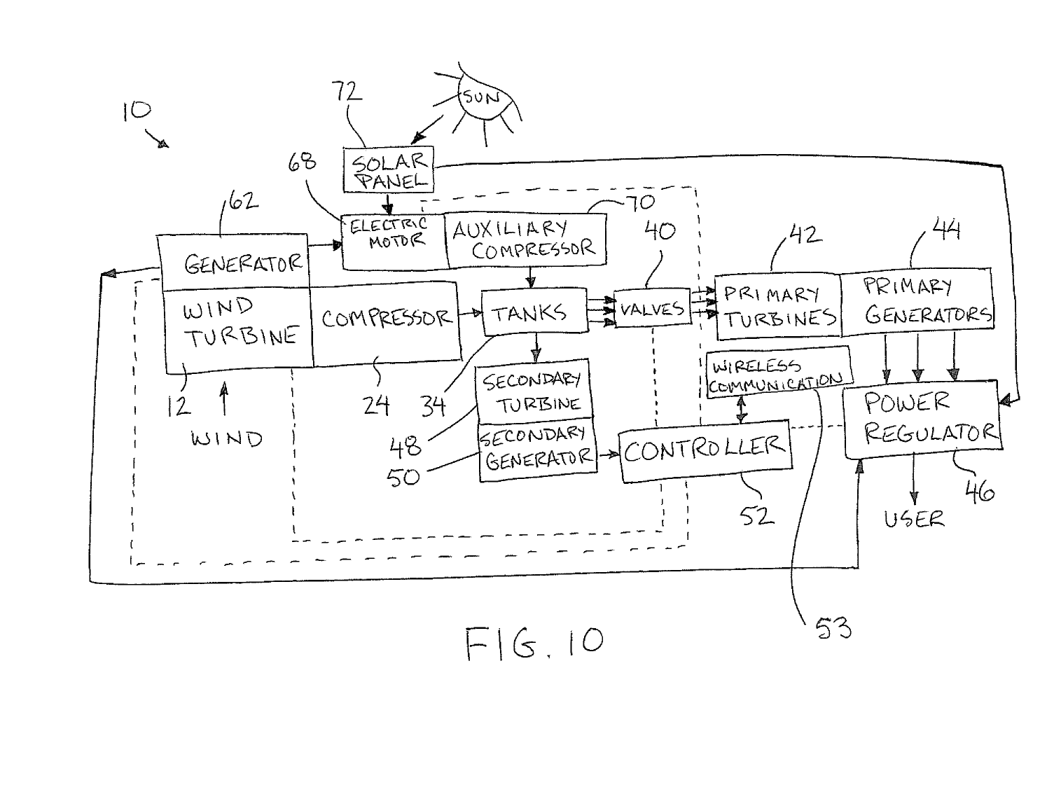

FIG. 3.

FIG. 5 is a sectional view along the line A-A of FIG. 2 according to a second embodiment of the vertical-axis turbine.

FIG. 6 is a partly sectional perspective view of the turbine according to

FIG. 5.

FIG. 7 is a sectional view along the line A-A of FIG. 2 according to a third embodiment of the vertical-axis turbine.

FIG. 8 is a sectional view along the line A-A of FIG. 2 according to a fourth embodiment of the vertical-axis turbine.

FIG. 9 is a perspective view of a communicating member for connection between the turbine and compressor assembly and the compressed air storage containers.

FIG. 10 is a block diagram of the various components of the wind energy system.

In the drawings like characters of reference indicate corresponding parts in the different figures.

### DETAILED DESCRIPTION

Referring to the accompanying figures there is illustrated a wind energy generating and storing system generally indicated by reference numeral 10. The system 10 is particularly suited for capturing wind energy and using the wind energy to compress air which is stored by the system for subsequent controlled release to drive suitable equipment which converts the wind energy to other useful energy forms, for example electricity and the like, on demand. Although various embodiments are described and illustrated in the following, the common features of the various embodiments will first be described herein.

The system 10 generally comprises a vertical axis lift type turbine 12 including a fixed supporting structure 14 such as a mast or tripod which supports the turbine spaced above the roof of a building for example. The turbine 12 also includes a turbine rotor 16 rotatably supported on the supporting structure 14 for rotation relative to the supporting structure about a vertical axis.

The turbine rotor 16 comprises a main body 18 at the central vertical axis and a plurality of turbine blades 20 spaced radially outward from the main body 18 at circumferentially spaced positions thereabout. Each of the turbine blades 20 is an elongate member oriented in a vertical orientation to be parallel to the vertical axis of rotation. A cross section of each blade 20 is generally in the shape of an airfoil with the blades being oriented in a common direction of rotation at a suitable inclination relative to the direction of rotation such that the turbine blades 20 are arranged to generate a torque acting on the main body 18 in the operating direction when the rotor 16 rotates in the operating direction responsive to a generally horizontal wind across the blades.

The turbine blades 20 are supported by respective support arms 22 at a plurality of vertically spaced positions respectively. Two or more support arms 22 span radially outward from the main body 18 vertically spaced from one another in a generally horizontal direction for connection to each of the blades adjacent respective opposing top and bottom ends of the blade. Each of the support arms 22 also includes a general airfoil shape in cross section with the support arms being suitably oriented to generate a force in the axial direction of the vertical axis when the turbine is rotated in the operating direction responsive to the horizontal wind across the blades.

The turbine 12 is integrally supported with an air compressor 24 which is directly and integrally driven by the turbine. The air compressor 24 comprises a stator 26 which is fixed relative to the supporting structure 14 of the turbine, and a compressor rotor 28 which rotates relative to the stator 26 about the vertical axis of the turbine together and integrally with the turbine rotor 16 as the compressor rotor and the turbine rotor form a common body supported for rotation by common bearings on the fixed supporting structure 14.

In the illustrated embodiments, the air compressor 24 comprises a spiral compressor in which a spiral member 30 is rotated within a surrounding housing 32 such that cooperating surfaces of the spiral member and the housing 32 are arranged to compress air therebetween in sequential stages from an inlet end at the top end of the air compressor to an outlet end at the bottom end of the stator of the air compressor. The spiral compressor may be configured similarly to the spiral compressor described in U.S. Pat. No. 4,859,159, the disclosure of which is incorporated herein by reference.

The outlet end of the air compressor is connected to a plurality of compressed air storage tanks connected in parallel with one another by inlet manifold 36 in communication with the inlet ends of the tanks and an outlet manifold 38 in communication with the respective outlets of the tanks. Each of the tank inlets receives compressed air from the air compressor through a respective valve mechanism which controllably selects which of the tanks is arranged to receive compressed air at any given time. Similarly a valve mechanism 40 is provided in communication with the outlet of each tank to controllably select which tank dispenses compressed air therefrom for subsequent use by air driven equipment.

The outlets of compressed air storage tanks or containers 34 are coupled to a plurality of primary turbines 42 for driving respective primary generators by direct drive connection therebetween. Each of the primary generators is arranged to generate an electric current responsive to a flow of compressed air being received by the corresponding primary turbine associated therewith. The primary electricity is delivered to a power regulator 46 for use by an end user, for example a home or other building use, or for returning surplus power to the electric power grid.

Each of the primary turbines 42 and the primary generators 44 associated therewith receive air through a respective airline and control valve for controlling which of the turbine and generator pairs receives a flow of compressed air. When there is greater demand for electricity, a larger flow of compressed air is released from the compressed air storage tanks by the valves for operating a greater number of primary turbines which in turn produces greater primary electricity for end use.

A secondary air passage in the form of a branched line communicates from the compressed air storage tanks to a secondary turbine 48 which is arranged to be driven by the flow of compressed air received from the tanks to drive a corresponding secondary generator 50 integrally formed therewith. The secondary generator is arranged to generate an electrical current in the form of secondary electricity which is smaller in volume than the primary electricity generated due to the secondary line communicating to the secondary turbine being smaller to accommodate less flow than any of the primary airlines of the primary turbines. The secondary airline is arranged however to provide a constant flow of air to the secondary turbine which is operated continuously to provide continuous secondary electricity which in turn powers a controller 52 of the wind energy system independently of grid power or power generated by the primary turbines.

The electrical controller 52 is arranged to operate all of the various valves of the wind energy system, the power regulator, the switching activation of any of the turbines and generators, the actuation of any of the compressors, and or generators while also being arranged to monitor the condition of the turbine to determine if braking is necessary, as well as the condition of the compressed air storage tanks for selecting which tanks are in need of receiving compressed air from the turbine and compressor assembly and for determining from which tanks compressed air can be released for subsequent use.

The controller 52 communicates with a wireless communicating element 53 which is also powered by the secondary electricity from the secondary generator 50 through the controller 52 which controls communication of the various components of the system 10 with the wireless communicating element 53. The wireless communication element 53 permits communication in a wireless manner using various available wireless technologies between the components of the system 10 and a user which is located remotely from the system 10. The user can thus wirelessly transmit instructions to the controller 52 which in turn controls the various components of the system 10 for operating the system 10 remotely via internet, wireless network, or other suitable means.

After the compressed air is released to the primary and secondary generators driven by compressed airflows, the exhaust air can be redirected to a building ventilation system where cooling is desired for air conditioning for example or for other applications where cooling is desired, or alternatively if no cooling requirements are present, the exhaust air can be vented to atmosphere. A directional valve 54 which controls the direction of the generator exhaust is also controlled by the controller 52.

In a typical installation of the system, the compressor and turbine assembly are supported together on the roof of a building and the like while the storage tanks together with the primary and secondary turbines and generators are supported separately at a remote location, for example with the interior of the building such that compressed air is communicated from the direct driven air compressor 24 to the compressed air storage tank through a plurality of interconnected modular communicating members 56.

Each of the communicating members 56 is arranged to be connected in series in an end to end configuration with other identical ones of the communicating members 56. More particularly each member 56 includes a main tubular body which is elongate in a longitudinal direction for defining a compressed air passage extending longitudinally therethrough between a pair of tubing connectors at opposing ends thereof.

Integrally supported alongside the air passage 58 is an electrical communicating member 60 which extends between electrical connectors at opposing ends of the member 56. The electrical communicating member 60 may be attached alongside the tubing or integrally formed or molded within the tubing wall to communicate electricity generated by an optional generator at the wind turbine as well as providing various electrical communication between the turbine and the controller 52 including sensed conditions of the turbine and various instructions to the turbine including braking if excessive wind speeds are reached for example.

The electrical connectors and the tubing connectors at opposing ends of each communicating member 56 are arranged for quick connection to corresponding ones of the tubing and electrical connectors of adjacent ones of the members 56 with the connectors being positioned such that the electrical connectors and tubing connectors are simultaneously connected as the modular communicating members are connected in end to end configuration.

Turning now more particularly to the embodiment of FIG. 3, the compressor rotor in this instance comprises the housing of the spiral compressor such that the housing is rotatable about the spiral member which defines the stator of the compressor. The housing is a generally cylindrical member which surrounds the central spiral member such that the inner surface of the tubular housing defines the cooperating surface of the compressor against which air is compressed in cooperation with the spiral member. The outer surface of the same body forming the tubular housing of the compressor rotor defines the body of the turbine rotor such that the turbine rotor together with the compressor rotor fully surrounds the spiral member of the compressor for rotation thereabout.

Atmospheric air is drawn in through the inlet end at the top of the housing to be collected at the bottom end defining the outlet end of the compressor which directs air under compression through the communicating members to the compressed air storage tanks. The top end of the housing defining the compressor rotor is joined integrally with the top end of the turbine rotor with the turbine blades being in horizontal alignment with spiral member about which the blades rotate. Bearing support is provided both above and below the compressor and turbine rotors for supporting the rotors on the supporting structure of the turbine.

Turning now to the embodiment of FIG. 5, in this instance the compressor stator comprises the housing which remains fixed and which surrounds the central compressor rotor defining the spiral member which rotates relative to the housing to compress air therebetween from the inlet end to the outlet end of the compressor. The top end of the spiral member is joined integrally with the top end of the turbine rotor in this instance similarly to the previous embodiment.

The turbine rotor in the embodiment of FIG. 5 differs from the previous embodiment in that the turbine rotor comprises a tubular body in the form of a casing which fully surrounds the housing of the spiral compressor. The turbine blades are in turn supported by the support arms on the external surface of the casing which surrounds the housing of the compressor so that the turbine blades again surround the spiral member of the compressor located centrally at the vertical axis of the turbine at a common elevation therewith. Bearing support is again provided between the turbine rotor and the housing of the compressor which defines the supporting structure of the turbine. The bearings between the turbine rotor and the housing of the compressor upon which the turbine rotor is supported may be provided at top and bottom ends of the both the turbine rotor and the stator of the compressor.

Turning now to the embodiment of FIG. 7, the compressor stator again comprises the housing of the spiral compressor which is fixed relative to the supporting structure of the turbine and which centrally receives the spiral member defining the compressor rotor rotatably therein. The body of the turbine rotor in this instance is again formed integrally with the spiral member defining the compressor rotor, however in this instance the body of the turbine rotor is supporting at the top of the compressor rotor to extend upwardly therefrom such that the body of the turbine rotor is supported fully above the spiral member and the blades are attached to the turbine for rotation above the compressor. In this instance axially spaced bearing support is provided between the spiral member and the surrounding housing at opposed top and bottom ends of the compressor.

Turning now to the embodiment of FIG. 8, the turbine is configured substantially identically to the embodiment of FIG. 3 such that the spiral member of the compressor is fixed onto the supporting structure of the turbine while the compressor housing defines the compressor rotor and turbine rotor integrally with one another for rotation about the spiral member together with the turbine blades supported on the integral body of the turbine and compressor rotors.

The embodiment of FIG. 8 differs from previous embodiments in that an electrical generator 62 is provided for generating an electric current responsive to relative rotation thereof. The electrical generator 62 includes a permanent magnet 64 which is fixed onto the bottom end of the integral turbine and compressor rotor body for rotation therewith about the spiral member of the compressor fixed on the supporting structure of the turbine. An electromagnetic coil 66 is also supported in fixed relation on the supporting structure of the turbine adjacent the bottom end of the spiral member of the compressor in axial alignment with the permanent magnets 64 which rotate about the electromagnetic coil centrally located at the vertical axis of the turbine.

An electrical current is generated in the coil responsive to rotation of the permanent magnet 64 thereabout in the operating direction of the turbine. The current generated by the generator 62 is typically directed to the power regulator of the system for subsequent use by an end user for example.

In another arrangement the generator may also supply electric current to an electric motor 68 used to drive rotation of an auxiliary compressor 70 coupled integrally with the electric motor to be directly driven thereby. The auxiliary compressor comprises a suitable air compressor arranged to compress an additional flow of air to be stored in the compressed air storage tanks as may be desired. Operation of both the generator and the electric motor of the auxiliary compressor are monitored and controlled by the controller 52 noted above. In yet further arrangements the electrical current generated by the generator can be used to provide electrical power to the controller in addition to or in place of the secondary generator.

In an alternative mode of operation, braking can be provided to the rotation of the wind turbine if excessive wind speeds are reached by action of the controller operating the generator in a braking mode. In the braking mode, electric current is delivered to the electromagnetic coil 66 of the generator to produce a magnetic field opposite the field of the permanent magnets 64 which effectively provides a force which urges rotation of the turbine against the operating direction to resist rotation in the operating direction as may be required.

In further embodiments the orientation of the support arms can be adjusted as controlled by the controller for optimizing the efficiency of the compressor in different operating conditions. By varying the direction or orientation, the amount of lift in the axial direction provided to the compressor can be adjusted so that an axially upward force may be provided by the support arms on the turbine to balance the weight of the turbine and compressor rotors for reducing friction.

In alternative arrangements, when sealing members are provided between the stator and compressor rotor, a compressive force in the axial direction may be provided by the support arms to compress the sealing members between the rotor and stator of the compressor for more effective sealing in an adjustable manner by adjustment of the orientation of the support arms.

As described herein, a wind energy system is disclosed in which the compressor and turbine are integrated with one another to eliminate energy loss by eliminating mechanical energy transfer between the two components when the components are integrally rotated together as a single body. Furthermore the adjustment of the profile of turbine blades and support arms thereof to provide an upwards or downward force in the axial direction can improve the compressor performance. By also powering the controller using a constant flow of compressed air through a branched line from the compressed air storage tanks which is secondary to a main line that supplies the primary generators, a continuous flow of air can be used to provide constant power to the controller without the requirement of electrical storage batteries.

In further arrangements the auxiliary compressor 70 can be electrically driven by electrical current derived from a solar panel 72 which can be used in a first mode to power the auxiliary compressor or in a second mode to provide electrical power directly to the power regulator for subsequent use as may be required. The solar panel and the permanent magnet generator fixed directly onto the wind turbine are advantageous to provide additional electrical power for immediate use as may be desired. The permanent magnet generator in particular permits a dual efficiency of the wind turbine since the unit will already be spinning to compress air. By having the permanent magnet generator present, it is possible to dump the electrical current back into the magnet and short the system, thereby acting as the braking mechanism. The permanent magnet generator driven by the wind or use of an auxiliary air compressor driven by an electric motor by wind or solar energy sources can exist independently of each other. In either case the magnet generator and the electric motor would be mounted at either the top or bottom of the unit dependent upon the design.

As described herein, three aerodynamic blades are mounted vertically and attached at circumferentially spaced positions about a central column. In further embodiments however, any number of blades may be evenly circumferentially spaced about the vertical axis of rotation. For example the rotor of the turbine may comprise 4 or 5 blades while still realising the advantages of the various embodiments described herein.

Also as described herein, the compressor is a spiral-type, 2-stage air compressor. In further embodiments, the compressor may comprise any rotary type compressor which includes a rotor 28 and a stator 26 which are rotatable relative to one another to compress air from the inlet to the outlet of the compressor.

As described herein with regard to the preferred embodiments, the compressor is integrally connected to the turbine such that the two components are directly rotated together. In further embodiments however, the compressor and turbine may be coupled by various drive transmissions including gear sets and the like while still realising the other advantages of the present invention as described herein.

The compressor described in the above description is intended to be one example of a turbomachine to which various features of the present invention may relate. In further embodiments, the compressor may be substituted for any type of pump, compressor, auger or other turbomachinery capable of converting a rotating mechanical input from the turbine rotor into a movement of a fluid including incompressible fluids such as water or compressible fluids such as a gas which is compressed by the turbomachine.

In all embodiments, the struts used to attach the vertical blades to the central column are aerodynamic in profile in order to increase wind capture efficiency.

Hard mounted directly below the output of the compressor is a shut-off valve. The valve controls air-flow, and can be used to slow or stop the rotation of the air-compressor. The valve is a variable state valve not a binary, open-close, state valve. This valve, like all valves in this system, is controlled by the controller 52.

The compressed air passes through a tube to the tank control valve. The tube, like all tubes in this patent, has a hard-mounted wire which terminates in a contact point for connection to another tube, valve, or electronic system. The tank control valve adjusts the rate of air flow. There are tank control valves on both ends of the compressed air tanks. Air flows past the tank control valve on the output side of the compressed air tanks to the auxiliary valve. The auxiliary valve controls air flow to the auxiliary output turbines. The auxiliary output turbines are additional turbines which can be mounted in parallel so as to provide additional wattage, or alternative amperage outputs.

The main airflow passes through the auxiliary valve to the output turbine. Immediately upstream of the main output turbine is the accessory pack output turbine. The accessory pack output turbine provides power to the accessories pack.

The accessories pack contains a wi-fi transmitter, the valve control system, and the electrical output systems. The wi-fi transmitter sends and receives regular wireless internet traffic in addition to permitting wireless control of the system. The valve control system regulates all the valves in the system.

The electrical output system contains all the components necessary to convert electricity from output turbines into power ready for the end user. The airflow past the main output turbine is controlled by adjusting the electrical load on the turbine. Increasing the electrical load on the main output turbine will decrease rate of rotation, and therefore the airflow. This decreased airflow increases the amount of time the system has “battery-life”. The electrical output system senses when the demand is coming from the end-user (home, business, etc), and activates the main output turbine. Under normal operating conditions, the auxiliary output turbine is always on in a ready-state. This ready-state reduces the delay between demand and start-up often associated with compressed air energy storage systems.

Airflow leaving the main output turbine passes through the output direction valve. The output direction valve adjusts the amount of airflow traveling to the air conditioning unit. Since air cools as it expands, energy is saved by having the expelled air diverted to the air conditioning system. The unused expelled air is diverted outside.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A wind energy system comprising:
a vertical-axis turbine comprising:
a supporting structure;
a turbine rotor supported on the supporting structure for rotation about a vertical axis relative to the supporting structure;
a plurality of turbine blades supported on the turbine rotor at circumferentially spaced locations about the vertical axis so as to be rotatable with the rotor about the vertical axis; and
a plurality of support arms spanning radially outward from the turbine rotor to support the turbine blades thereon spaced outwardly from the rotor;
the turbine blades of the vertical-axis turbine having an airfoil shape in cross section and being oriented such that the blades generate a torque in an operating direction of rotation of the turbine about the vertical axis responsive to a generally horizontal wind across the blades as the blades are rotated in the operating direction of rotation;
the support arms of the vertical-axis turbine having an airfoil shape in cross section and being oriented such that the support arms generate a load on the turbine rotor in an axial direction of the vertical axis responsive to rotation of the rotor in the operating direction of rotation;
a turbomachine comprising a casing and a turbomachine rotor which are rotatable relative to one another, one of the casing and the turbomachine rotor being coupled to the turbine rotor so as to rotate responsive to rotation of the turbine rotor.

2. The system according to claim 1 wherein the turbomachine comprises an air compressor comprising:
a stator including an inlet end and an outlet end; and
a compressor rotor supported for rotation relative to the stator about the vertical axis of the vertical-axis turbine;
the compressor rotor being arranged to compress air from the inlet end to the outlet end of the stator responsive to rotation of the compressor rotor relative to the stator; and
the compressor rotor being coupled to the turbine rotor so as to rotate responsive to rotation of the turbine rotor.

3. The system according to claim 1 wherein the support arms are oriented such that the support arms are arranged to provide an upward lifting force to the turbine rotor responsive to rotation of the turbine rotor in the operating direction of rotation.

4. The system according to claim 1 wherein there is provided at least one sealing member in sealing engagement between the casing and the turbomachine rotor and wherein the support arms are oriented such that the support arms are arranged to provide a compressive force in an axial direction of the vertical axis on said at least one sealing member in sealing engagement between the casing and the turbomachine rotor.

5. The system according to claim 1 wherein one of the casing and the turbomachine rotor are integrally coupled with the turbine rotor so as to be rotatable together about the vertical axis.

6. The system according to claim 2 wherein the air compressor comprises a spiral compressor in which one of the compressor rotor and the stator comprises a housing and the other one of the compressor rotor and the stator comprises a spiral member supported within the housing for rotation relative to the housing about the vertical axis, the housing and the spiral member comprising cooperating surfaces arranged to compress air therebetween from the inlet end to the outlet end responsive to relative rotation between the housing and the spiral member.

7. The system according to claim 2 wherein the stator comprises the spiral member and the compressor rotor comprises the housing, the turbine rotor being formed integrally with the compressor rotor such that the turbine blades are supported directly on the housing of the air compressor for rotation together therewith about the spiral member.

8. (canceled)

9. (canceled)

10. The system according to claim 2 further comprising:
at least one compressed air storage container in communication with the outlet end of the stator of the air compressor so as to be arranged to receive and store compressed air therein;
an electric controller arranged to controllably release a flow of compressed air from said at least one compressed air storage container;
a primary compressed air driven generator arranged to generate primary electricity responsive to a flow of compressed air;
a secondary compressed air driven generator arranged to generate secondary electricity responsive to a flow of compressed air; and
the electric controller being operable using the secondary electricity generated by the secondary compressed air driven generator.

11. The system according to claim 10 wherein the primary and secondary compressed air driven generators are coupled to said at least one compressed air storage container such that the secondary compressed air driven generator receives a smaller flow of compressed air than the primary compressed air driven generator.

12. The system according to claim 10 wherein the secondary compressed air driven generator is coupled to said at least one compressed air storage container such that the secondary compressed air driven generator receives a continuous flow of compressed air.

13. The system according to claim 10 wherein there is provided an electrical power regulator arranged to regulate the primary electricity generated by the primary compressed air driven generator, the electrical power regulator being operable using secondary electricity generated by the secondary compressed air driven generator.

14. The system according to claim 10 wherein there is provided a plurality of primary compressed air driven generators arranged to generate electricity responsive to a flow of compressed air, the plurality of primary compressed air driven generators being selectively operable in stages by the controller which uses the secondary electricity generated by the secondary compressed air driven generator.

15. The system according to claim 10 wherein there is provided a valve mechanism arranged to controllably communicate compressed air from said at least one compressed air storage container to the primary compressed air generator and the controller is arranged to control the valve mechanism using the secondary electricity generated by the secondary compressed air driven generator.

16. The system according to claim 1 wherein there is provided a permanent magnet electric generator comprising an electromagnetic coil and a permanent magnet supported for rotation relative to the electromagnetic coil, one of the permanent magnet and the electromagnetic coil being coupled to the turbine rotor for rotation therewith about the vertical axis of the turbine such that the electromagnetic coil is arranged to generate an electrical current responsive to rotation of the turbine rotor.

17. The system according to claim 16 wherein the electromagnetic coil is supported on the supporting structure and the permanent magnet is supported on the turbine rotor for rotation about the electromagnetic coil.

18. The system according to claim 17 wherein there is provided an electrical controller arranged to supply electrical current to the electromagnetic coil such that the electromagnetic coil resists movement relative to the permanent magnet in the operating direction of rotation.

19. The system according to claim 16 wherein the turbomachine comprises an air compressor comprising:
a stator including an inlet end and an outlet end; and
a compressor rotor supported for rotation relative to the stator about the vertical axis of the vertical-axis turbine;
the compressor rotor being arranged to compress air from the inlet end to the outlet end of the stator responsive to rotation of the compressor rotor relative to the stator; and
the compressor rotor being coupled to the turbine rotor so as to rotate responsive to rotation of the turbine rotor;
the system further comprising:
at least one compressed air storage container in communication with the outlet end of the stator of the air compressor so as to be arranged to receive and store compressed air therein; and
an auxiliary compressor including a stator and compressor rotor driven by an electric motor and arranged to compressed air and communicate the compressed air to said at least one compressed air storage container;
the electric motor being coupled to the permanent magnet electric generator such that the permanent magnet electric generator is arranged to drive the auxiliary compressor.

20. The system according to claim 1 wherein the turbomachine comprises an air compressor comprising:
a stator including an inlet end and an outlet end; and
a compressor rotor supported for rotation relative to the stator about the vertical axis of the vertical-axis turbine;
the compressor rotor being arranged to compress air from the inlet end to the outlet end of the stator responsive to rotation of the compressor rotor relative to the stator; and
the compressor rotor being coupled to the turbine rotor so as to rotate responsive to rotation of the turbine rotor;
the system further comprising:
at least one compressed air storage container in communication with the outlet end of the stator of the air compressor so as to be arranged to receive and store compressed air therein;
an auxiliary compressor including a stator and compressor rotor driven by an electric motor and arranged to compressed air and communicate the compressed air to said at least one compressed air storage container; and
a solar panel arranged to supply solar generated electricity to drive the electric motor of the auxiliary compressor.

21. The system according to claim 1 wherein the turbomachine comprises an air compressor comprising:
a stator including an inlet end and an outlet end; and
a compressor rotor supported for rotation relative to the stator about the vertical axis of the vertical-axis turbine;
the compressor rotor being arranged to compress air from the inlet end to the outlet end of the stator responsive to rotation of the compressor rotor relative to the stator; and
the compressor rotor being coupled to the turbine rotor so as to rotate responsive to rotation of the turbine rotor;
the system further comprising:
at least one compressed air storage container in communication with the outlet end of the stator of the air compressor so as to be arranged to receive and store compressed air therein;
a controller arranged to control operation of the turbine in which the controller and said at least one compressed air storage container are located at a remote location separate from the vertical-axis turbine;
a plurality of modular communicating members connected in series between the turbine and the remote location of the controller and said at least one compressed air storage container;
each communicating member comprising a compressed air passage in communication between opposed tubing connectors and an electrical communicating member integrally attached alongside the compressed air passage in communication between opposed electrical connectors;
the opposed electrical connectors being arranged for mating connection with the electrical connectors of adjacent ones of the communicating members together with mating connection of the tubing connectors with the tubing connectors of the adjacent ones of the communicating members.

22-38. (canceled)

39. A wind energy system comprising:
a vertical-axis turbine comprising:
a supporting structure;
a turbine rotor supported on the supporting structure for rotation about a vertical axis relative to the supporting structure; and
a plurality of turbine blades supported on the rotor at circumferentially spaced locations about the vertical axis so as to be rotatable with the rotor about the vertical axis;
the blades of the vertical-axis turbine having an airfoil shape in cross section and being oriented such that the blades generate a torque in an operating direction of rotation of the turbine about the vertical axis responsive to a generally horizontal wind across the blades as the blades are rotated in the operating direction of rotation;
a turbomachine comprising a casing and a turbomachine rotor which are rotatable relative to one another;
wherein one of the casing and the turbomachine rotor are integrally coupled with the turbine rotor so as to be rotatable together about the vertical axis.

40-50. (canceled)
